(19) United States
(12) Patent Application Publication
(10) Pub. No.: US 2014/0047675 A1
(43) Pub. Date: Feb. 20, 2014

(54) CLAMP FOR CONNECTING ROPES

(71) Applicant: BERLINER SEILFABRIK GMBH & CO., Berlin (DE)

(72) Inventor: Karl-Heinz KOEHLER, Berlin (DE)

(73) Assignee: BERLINER SEILFABRIK GMBH & CO., Berlin (DE)

(21) Appl. No.: 13/967,771

(22) Filed: Aug. 15, 2013

Related U.S. Application Data
(60) Provisional application No. 61/683,737, filed on Aug. 16, 2012.

(30) Foreign Application Priority Data
Aug. 16, 2012 (DE) 10 2012 214 557.5

(51) Int. Cl. F16G 11/02

(52) U.S. Cl. CPC F16G 11/02
USPC 24/129 W

(57) ABSTRACT

A clamp for connecting ropes comprises a material which can be deformed under pressure with two U-shaped recesses arranged on opposite sides of the single-piece clamp into which the rope strands to be connected can be inserted, wherein the arm-like walls of the U-shaped recesses are pressed together and deformed following insertion of the rope strands, in order to form a ring which surrounds each rope strand, wherein the clamp prior to deformation essentially comprises the form of a double cone including of two cone stumps, and the U-shaped recesses are arranged respectively in the cone stump, which is characterized in that the arm-like walls comprise at least one elevation facing toward the U-shaped recess, wherein the distance between the elevation and the opposite arm-like wall is slightly smaller than a diameter (D) of the rope strands to be connected.

The invention relates to a clamp for connecting ropes with the features listed in the generic term of claim 1, together with a net made of rope strands connected by means of clamps.

A clamp of the generic type is known. Thus, EP 0 007 607 B1 discloses a clamp for connecting ropes, in particular for creating nets, consisting of a material which can be deformed under pressure, with U-shaped recesses arranged on opposite sides of the single-piece clamp, into which the rope strands to be connected can be inserted. The arm-like walls of the U-shped recesses are following insertion of the rope strands pressed together and deformed in order to form a ring which surrounds each rope strand. The clamp essentially has the form of a double cone including two cone stumps prior to deformation, wherein the U-shaped recesses are arranged in each cone stump.

Clamps of this type are used for example for ropes, such as wire ropes, or ropes made of textile fibres, wherein the ropes are designed for use e.g. as climbing nets for childrens' playgrounds or similar. By means of the clamp, ropes which intersect each other are connected to each other at a intersection point.

A disadvantage of the aforenamed clamp is that following insertion of the ropes into the clamp, the clamp must here be affixed in relation to the ropes. The U-shaped recesses, into which the ropes are inserted, are equal in size or are slightly larger than the circumference of the ropes to be connected. As a result, the ropes can accidentally slip out or slide from the U-shaped recesses—before the clamps are pressed. An additional positioning before pressing or immediate pressing combined with the required holding of the position of the ropes is therefore necessary. Precisely when clamps of this type are intended for pressing on location, i.e. away from the workshop, this results in a significant complication of the procedure.

The object of the invention is thus to create a clamp of the generic type with which simple pre-positioning of the ropes to be connected is possible.

According to the invention, this object is attained by means of a clamp with the features named in claim 1.

Due to the fact that the arm-like walls comprise at least one elevation in the direction of the U-shaped recess, wherein a distance between opposite elevations is slightly less than a diameter of the rope strands to be connected, it is advantageously achieved that between the clamps which are not yet deformed and the rope strands to be connected, a type of pre-mounting state can be achieved.

This can also be achieved by the fact that only one of the arm-like walls of a U-shaped recess comprises at least one elevation which points in the direction of the U-shaped recess, wherein the distance between the elevation and the opposite arm-like wall is slightly less than a diameter of the rope strands to be connected.

The ropes are held in the required position by the extensions which protrude into the U-shaped recess. The rope strands latch as it were into the not yet formed clamps and retain the position they have already adopted. The rope strands themselves consist of a number of rope cords, providing a certain degree of elasticity in the radial direction. This enables the rope strands to be connected to be deformed in at least a partially elastic manner, and the extensions can fit into the not yet deformed clamp when inserted. The extensions then hold the rope strands in this position. The extensions can grip between the cords or between outside wires or garns of the rope strands, as a result of which the rope strands can also be pre-fixed in the axial direction.

In a preferred embodiment of the invention, it is provided that the elevations comprise at least one bead. Here, it is advantageously possible to integrate the elevations in a simple manner into the unfinished clamp, i.e. into the clamp prior to deformation. These beads can in a simple manner be integrated as a single piece during the manufacturing process of the clamp.

In a further preferred embodiment of the invention, it is provided that a distance bewteen the beads and the base of the U-shaped recesses is greater than half a diameter and less than the diameter of the rope strands to be connected, in particular three-quarters, preferably two-thirds of the diameter of the rope strands to be connected. As a result it is advantageously possible to arrange the bead-like elevations in such a manner that the rope strands as it were latch into the U-shaped recesses, and that these at the same time adopt their required position prior to pressing the clamp. The rope strands lie as it were with their circumference on the U-shaped recess which is adapted to the circumference, and are affixed in the direction of the openings of the U-shaped recesses, as well as axially.

The elevation can extend in a longitudinal or axial direction which runs parallel to the two arm walls of a U-shaped recesses over the entire length of the arm wall. This has the advantage of increased adhesive force compared to a shorter elevation. The length of the elevation can for example be measured on the basis of the rope material and/or the use of the net.

Advantageously, an arm wall can have several elevations, wherein the elevations are arranged in a longitudinal direction which runs parallel to both arm walls of a U-shaped recess. Thus, there is secure positioning of the rope over the length of the recess, while the force for inserting the rope into the recess, i.e. behind the elevations, does not increase in comparison with an elevation, or only increases insignificantly.

In a preferred embodiment of the invention, it is provided that an extension of the elevation of the arm wall corresponds to the diameter of a cord of the rope strand. This enables a secure positioning of the rope strand.

The elevation can runs from a wall over a base of the recess to the opposite wall. This continuous elevation has an increased clamping effect and is easier to create.

According to a further aspect of the invention, a net consists of ropes with rope strands and at least one clamp as described above, wherein two rope strands are connected by means of a clamp. The same advantages and modifications apply as those described above.

The invention will now be explained in greater detail below in the exemplary embodiments and with reference to the associated drawings, in which:

FIG. 1 shows a perspective view of two intersecting ropes which are connected by means of a clamp according to the invention

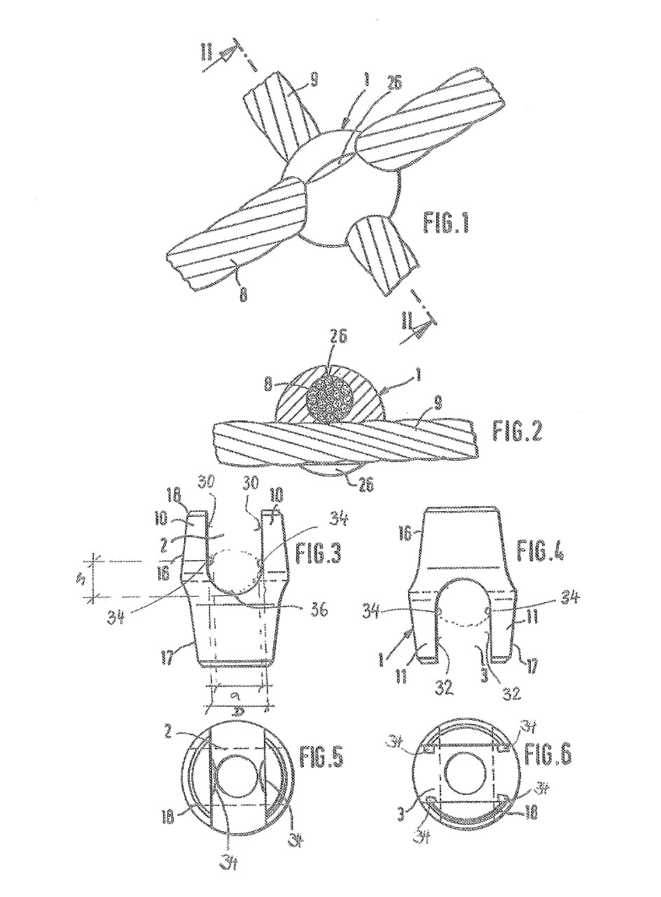

FIG. 2 shows a cross-section through the view shown in FIG. 1 according to cross-section line II-II

FIGS. 3 to 6 show two views, a top view and a view from below, of the clamp according to FIGS. 1 and 2

FIG. 7 shows a side view of a clamp according to the invention in a processed state in a modified embodiment

FIG. 8 shows a top view onto an exemplary embodiment shown in FIG. 7

FIGS. 9 to 11 show two side views and a top view of the exemplary embodiment which is shown in FIGS. 7 and 8

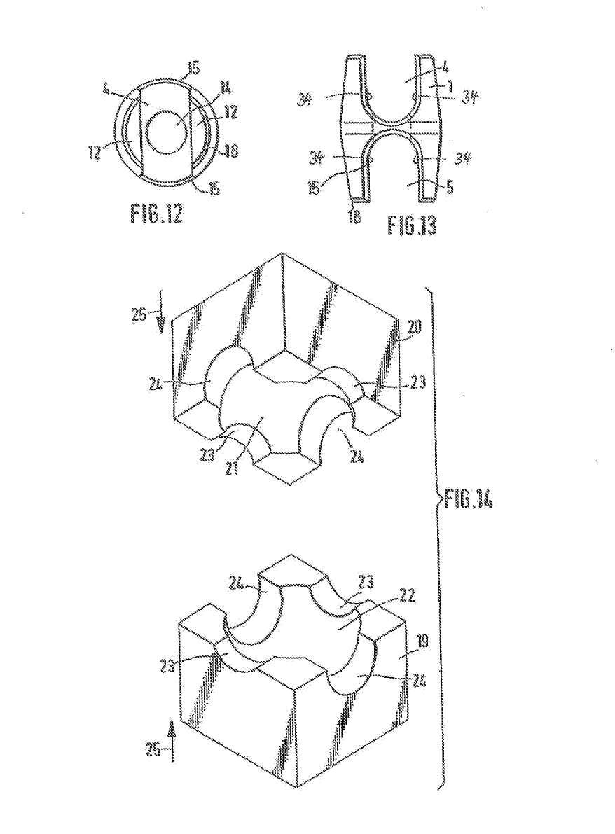

FIGS. 12 and 13 show a modified embodiment of the invention in a top view and a side view

FIG. 14 shows a perspective view of the tool used for the invention

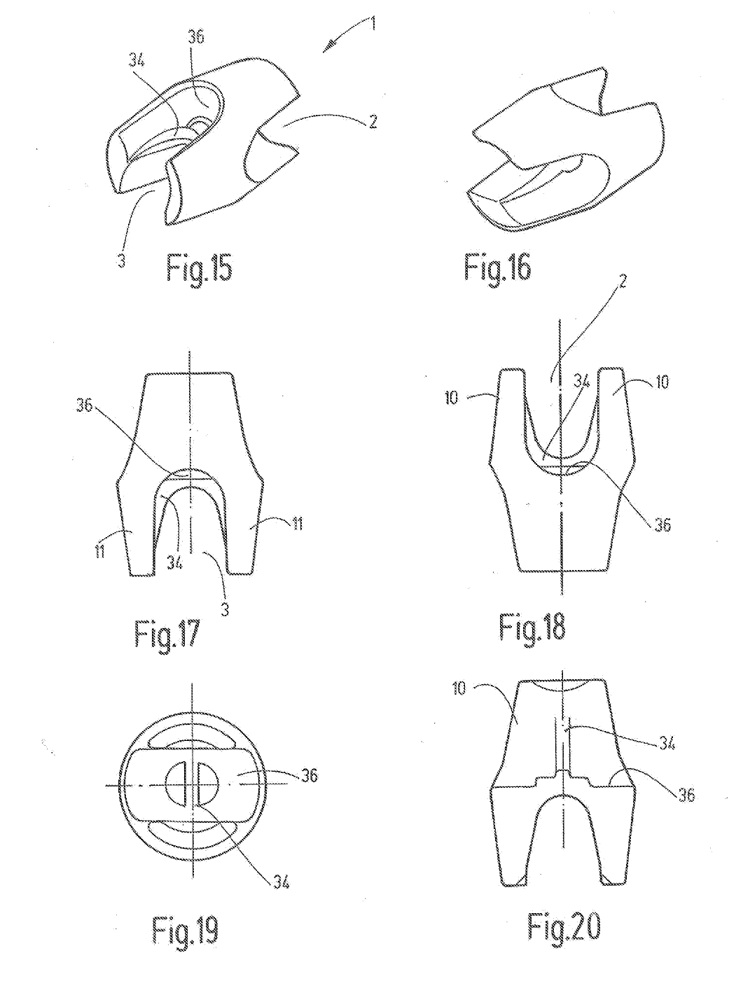

FIGS. 15 and 16 show a perspective view of a further embodiment of the clamp according to the invention, and

FIGS. 17 to 20 show two views, a top view and a cross-section view, of the clamp according to FIGS. 15 and 16

The clamp 1 according to the invention is preferably made of aluminium. However, another material can be used, such as steel or plastic, wherein with plastic, heat can also be applied for the purpose of deformation.

The clamp 1 according to FIGS. 1 to 6 is made of a rotation body and the form is gained in such a manner that initially, a double cone is essentially formed which consists of the two cones 16 and 17. The cone angle is in each case approx. 15°, although fluctuations of between 10° and 20° are possible. In this manner, an advantageous ratio is achieved between the outer dimensions on the one hand and on the other, the deformation forces or dimensions in a finished state.

The recesses 2 and 3 are inserted into the double cone, wherein the depth of these recesses is selected in such a manner that its total is somewhat higher than the overall height of the clamp. In this manner, it is achieved that these recesses 2 and 3 penetrate in the central area. As a result of this structure, the rope strands 8 and 9 are deformed at the point of contact, which offers the advantage that the total dimensions of the clamp 1 are somewhat reduced in a finished state.

Recess 2 is bordered by the walls 10, while recess 3 is bordered by the walls 11. It is recommended that bevelled edges 18 are arranged on the upper and lower end of the unfinished clamp to be deformed.

In order to achieve a clamp connection, in recess 2 for example the rope strand 8 of two intersecting rope strands is inserted, while recess 3 retains the other rope strand 9. The connection point provided in this manner is inserted into a tool which consists of two parts which are essentially of the same shape, as is shown in FIG. 14.

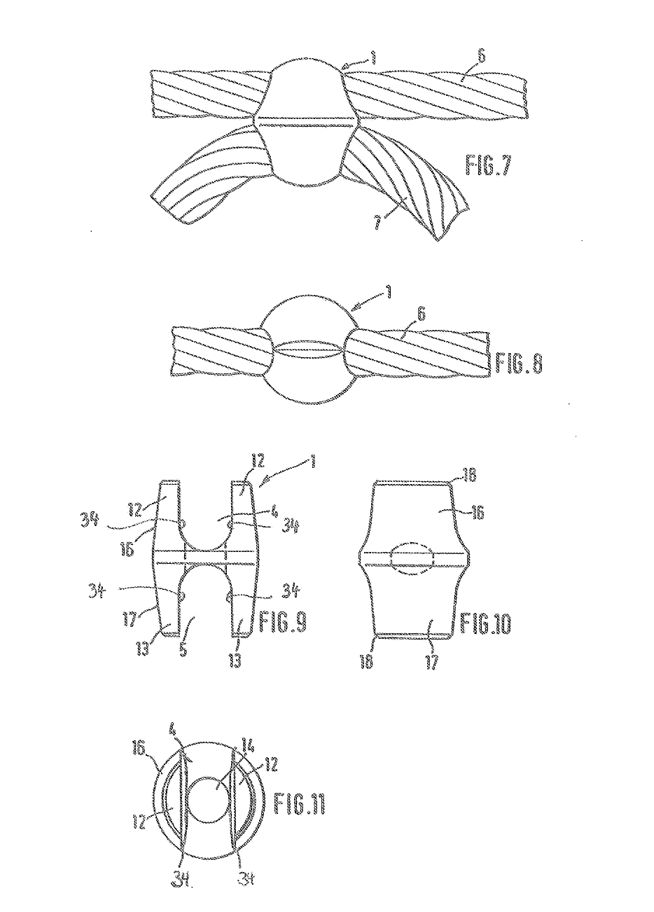

With reference to FIGS. 3 and 6, it becomes clear that on the inner sides 30 or inner sides 32 of the walls 10 or 11, elevations or protrusions 34 are provided. These elevations 34 are formed by opposite beads and lead to a partial tapering of the profile of the U-shaped recesses 2 or 3. A distance a between the bead-like elevations 34 is here selected in such a manner that it is less than a diameter D of the rope strands to be connected. A distance h between the beads from a base 36 of the recesses 2 or 3 is here greater than half a diameter D of the rope strands to be connected. The distance h is here for example three-quarters or two-thirds of the diameter D of the rope strands to be connected.

The data is only entered for FIG. 3, but naturally also applies to the view shown in FIG. 4.

With the inserted rope strands 8 or 9 to be connected which are shown in FIGS. 3 and 4, it becomes clear that they can be inserted from above into the U-shaped recess 2 or 3 and be held by the bead-like elevations 34 on the base 36 of the recesses 2 or 3. A low level of force must be applied, as it were, in order for the rope strands 8 or 9 to latch into the U-shaped recesses 2 or 3. These are then held in the selected position by the bead-like elevations 34 and cannot slip out alone from the recesses 2 or 3, i.e. without the application of an opposite force. As a result, it is achieved that a pre-fixing of the rope strands 8 and 9 to be connected is provided in the clamp 1 which is not yet deformed. With the later deformation, i.e. with the mounting of the clamp with the rope strands to be connected, a required position is thus securely maintained without requiring additional further auxiliary means. In particular, mounting on site is possible in a simple manner, since a pre-selected position of the rope strands 8 or 9 within the clamp 1 is maintained.

FIG. 5 shows in a top view onto the recess 2 two elevations 34 which each extend centrally over the length of approximately half of a wall in the longitudinal direction or the axial direction of the recess 2.

In FIG. 6, two elevations 34 respectively are shown for each wall, which are arrange din in succession in the longitudinal direction, i.e. at the same distance from the base of the recess. The length of the two elevations 34 can correspond to the length of the individual elevation in FIG. 5, so that the force for inserting the rope strand is identical.

According to a further embodiment version not shown, it is also possible that only one of the walls 10 and 11 has a bead-like elevation 34. A decisive factor is that this bead-like elevation 34 holds a rope strand 8 or 9 which has been brought into position in such a manner that it cannot slip.

Each of the two parts 19 and 20 of the tool shown in FIG. 14 has a semi-spherical shaped recess 21 or 22, and the walls outside of the recess 21 or 22 are fitted with semi-cylinder shaped recesses 23 or 24. The rope intersection with the non-deformed clamp is inserted into the tool in such a manner that for example the lower rope strand 9 is inserted into the recess 24 which is larger in size, and the two tool parts 19 and 20 are actively connected to each other in such a manner that the recesses 23 and 24 always complement each other. When a corresponding pressure is applied in the direction of the arrows 25, the clamp 1 is deformed in such a manner that essentially, a spherical shaped form is obtained. The walls 10 and 11 are here brought closer together until they touch each other. With the finished clamp, a small, wedge-shaped gap 26 is created.

The finished clamp only has comparatively small dimensions, which approximately correspond to each other in all directions. Generally, the retention forces achieved are sufficient.

The invention is particularly advantageous in that, as can be seen for example in FIG. 2, the base of the deformed walls 10 or 11 is relatively broad, so that even though the walls only touch following deformation and are not welded together or connected in any other manner, large retention forces are achieved.

The pressure forces, from which the retention forces depend, are to be adapted to the rope strands processed in each case. If wire ropes are processed, greater pressure forces can be applied than for example with ropes made of textile fibres or ropes in which the outside surface is formed from textile fibres.

While FIGS. 1 to 6 show the exemplary embodiment in which two intersecting rope strands 8 and 9 are connected, the version shown in FIGS. 7 to 11 is an exemplary application of the invention with parallel rope strands 6 and 7. The clamp 1 in this case also has U-shaped recesses 4 and 5, but as can clearly be seen in FIG. 9, they are aligned in parallel to each other. With this construction, it is also not possible for the recesses to penetrate each other, since this would divide the clamp. However, in order to ensure optimum deformability, it is recommended that a channel 14 is provided insdie the clamp.

The creation of the outer surface as a double cone 16 and 17 and the attachment of the bevelled edge 18 corresponds to the exemplary embodiment shown in FIGS. 1 to 6 described above.

In the exemplary embodiments shown in FIG. 9, the clamp 1 also has the bead-like elevations 34 described with reference to FIGS. 3 and 4. Reference is made to the explanations relating to FIGS. 3 and 4 with regard to the arrangement and function of these elevations 34.

Due to the special features of the exemplary embodiment shown in FIGS. 7 to 11, the finished clamp 1 in this case deviates somewhat more from the spherical form. At the level of the two rope strands 6 and 7, the dimensions are slightly larger than vertically to it, for example. However, these deviations are insignificant.

FIG. 11 shows in a top view onto the recess 4 two elevations 34 which each extend over the entire length of the wall 12 in the longitudinal direction or the axial direction of the recess 4.

Surprisingly, it has been found that the exemplary embodiment shown in FIGS. 7 to 11 can be processed using the same tool as the exemplary embodiment shown in FIGS. 1 to 6. Here, it is only necessary to turn the tool part 20 by 90° in relation to the tool part 19, so that respectively, recesses 23 or recesses 24 come together. The receses 23 are in this case without any function, and at the end of the pressing procedure, the tools maintain a distance from each other.

FIGS. 12 and 13 indicate a version of a clamp with which the boundaries 15 of the walls 12 and 13 of the U-shaped recesses 4 and 5 are bevelled. This bevelled edge is then also maintained on the finished clamp. An bevelled edge of this type causes the movability of the ropes held in the clamp to be improved somewhat, and the risk of the boundaries of the outer walls cutting sharply into the rope is removed.

FIG. 12 shows in a top view onto the recess 4 two elevations 34 which are each arranged centrally on the wall 12.

The embodiment version shown in FIG. 13 has the bead-like elevations 34 for affixing the rope strands to be connected.

The bevelled edges 15 can naturally also be used with a clamp with which the U-shaped recesses intersect, as is shown with the recesses 2 and 3 of the exemplary embodiment shown in FIGS. 1 to 6.

If in connection with the invention a spherical form is mentioned, which is designed to hold the clamp following deformation, this does not refer only to a geometrically precise sphere. Rotational bodies are also spherical-like, in which there are differences between the individual outer dimensions. If a curved outer form of the finished clamp is generally to be preferred, and offers the best results, outer forms can also be used which consist of individual surfaces which are in themselves planar, or of surfaces which have a lesser curve than the corresponding spherical form.

The clamp 1 according to FIGS. 15 to 20 has similiarities with the clamps in the preceding figures. For the sake of clarity, we here describe the differences, while otherwise, the explanations with reference to FIGS. 1 to 14 also apply here. The essential differences are that the elevation 24 is continuous, and the recesses 2 and 3 do not have a shared connection, i.e. they are separated from each other.

The clamp 1 consists of a double cone, wherein the cone angle is between 5° and 10°, preferably 7°.

The two U-shaped recesses 2 and 3 each have a base or a floor surface 36, so that the clamp 1 has a continjuous central section.

The recess 2 is bordered by the two walls 10 and the base 36. The recess 3 is bordered by the walls 11 and the base 36. In the recesses 2 and 3, an elevation 34 for pre-fixing a rope strand is provided in each case. The pre-fixing holds the rope strands or the clamp 1 in position, before the latter is deformed. For this purpose, the elevation 34 extends continuously from one wall 11 over the ground 36 to the opposite wall 11. The elevation here has an opening angle α of between 20° and 30°, preferably 26°. It has been shown that an opening angle α of this type enables the insertion and pre-fixing of a rope strand in a particularly advantageous manner.

As a result of the opening angle α, the height, i.e. the extension, of the elevation 34 over the wall 11 or over the base 36 is reduced. This causes the rope strand to be further affixed or clamped with further insertion or pressing into the opening 2 or 3. This causes the rope strand to be pre-fixed both in its radial and axial direction.

1. A clamp for connecting ropes, in particular for the formation of nets, consisting of a material which can be deformed under pressure with two U-shaped recesses arranged on opposite sides of the single-piece clamp into which the rope strands to be connected can be inserted, wherein the arm-like walls of the U-shaped recesses are pressed together and deformed following insertion of the rope strands, in order to form a ring which surrounds each rope strand, wherein the clamp prior to deformation essentially has the shape of a double cone including two cone stumps, and the U-shaped recesses are arranged respectively in the cone stump, wherein
at least one of the arm-like walls of a U-shaped recess comprises At least one elevation facing toward the U-shaped recess, wherein the distance between the elevation and the opposite arm-like wall is slightly smaller than a diameter (D) of the rope strands to be connected.

2. The clamp according to claim 1, wherein the arm-like walls comprise at least one elevation, wherein the distance of opposite elevations is slightly smaller than a diameter (D) of the rope strands to be connected.

3. The clamp according to claim 1, wherein the elevations comprise at least one bead.

4. The clamp according to claim 1, wherein a distance (h) of the elevations from the base of the U-shaped recesses is greater than half a diameter (D) and smaller than the diameter (D) of the rope strands to be connected, in particular three-quarters, preferably two-thirds of the diameter (D) of the rope strands to be connected.

5. The clamp according to claim 1, wherein the elevation extends in a longitudinal direction which runs parallel to both arm walls of a U-shaped recess over the entire length of the arm wall.

6. The clamp according to claim 1, wherein an arm wall comprises several elevations, wherein the elevations are arranged in a longitudinal direction which runs parallel to both arm walls of a U-shaped recess.

7. The clamp according to claim 1, wherein an extension of the elevation from the arm wall corresponds to the diameter of a cord of the rope strand.

8. The clamp according to claim 1, wherein the elevation runs from one wall over a base of the recess to the opposite wall.

9. A net consisting of ropes with rope strands and at least one clamp according to claim 1, wherein two rope strands are connected by means of a clamp.
